(19) United States
(12) Patent Application Publication
(10) Pub. No.: US 2005/0136986 A1
(43) Pub. Date: Jun. 23, 2005

(54) Occupant detection safety system and method of use

(76) Inventors: Cathy D. Santa Cruz, Reno, NV (US); Richard M. Early, Reno, NV (US); Thomas G. Eaton, Woodland, CA (US)

Correspondence Address: Cathy D. Santa Cruz, 7630 Tholl Drive, Reno, NV, 89506, US

(21) Appl. No.: 10/738,229

(22) Filed: Dec. 17, 2003

(51) Int. Cl. H04M 1/00

(52) U.S. Cl. 455/567

(57) ABSTRACT

An alarm and safety system used for detecting if an intruder is trying to abduct or kidnap an occupant while the occupant is sleeping, or the like. The safety system upon detection of the situation automatically actuates the alarm but more importantly simultaneously notifies ONSTAR™”, “AMBER ALERT™”, and or dials 911, each of which in turn notify proper emergency personnel. Thereafter, emergency personnel immediately call the residence and if no reply they will physically investigate the situation and respond accordingly. For additional safety, the system includes optional features that may be incorporated. For example, temperature, breathing sensors, and/or detection and recording means are inherent.

### FIELD OF THE INVENTION

This invention relates in general to alarm and safety systems used for monitoring presence and/or condition of an occupant when occupying a predetermined space. However, the invention more particularly pertains to a safety system that automatically activates an alarm as well as sends a signal for emergency assistance via emergency systems such as “ONSTAR™” and/or “AMBER ALERT™” or the like, upon detection of an emergency pertaining to the occupant. The system also includes novel features such as optional remote control, optional voice recognition and/or activation, etc.

### BACKGROUND OF THE INVENTION

Within today's society abduction and kidnapping have become a worldwide problem and heretofore there has not been an acceptable device or system which functions to deter such activities. Although the problem has been recognized and addressed within some of the known prior art there still remains a great need for improvement and a system that overcomes the problems associated therewith. Thus, the following are some examples of the known prior art and their disadvantages and drawbacks.

U.S. Pat. No. 4,951,032 entitled “CRIB RAIL SAFETY ANNUNCIATOR” is somewhat related to the present invention because of an alarm system which when installed onto the crib notifies an attendant of the child that the side rail has not been properly positioned, and/or in the up position. This is functional for its intended use but it certainly does not suffice as alarm system that would stop or deter a kidnapper or the like from taking the child, as does the present invention.

U.S. Pat. No. 5,640,145 entitled “REMOTE CONTROLED SYSTEM FOR MONITORING THE OCCUPANCY OF AN INFANT BEARING DEVICE” is much more closely related to the present invention but still includes disadvantages that the present invention recognizes, addresses and resolves. For example, the system is a remote controlled program module that allows a user to program a sleeping schedule, respectively, and if the child is removed from the bed at a non-scheduled time, the alarm is activated and even if the child is placed back into the bed, the alarm is not deactivated until after a predetermined time. This device is somewhat functional for its intended use but it is much too costly to produce and includes numerous electronics and sensors that the present invention eliminates.

U.S. Pat. No. 6,280,392 entitled “INFANT CONDITION MONITORING SYSTEM AND METHOD USING LOAD CELL SENSOR SHEET” is closely related to present invention because it does monitor an infant's condition, such as breathing, weight data and sleeping posture. However the receiver and/or controller, is to be carried by the attendant and the weight and sleeping signals are digitally displayed thereon. Also, if the child's breathing ceases then a speaker is activated to inform the attendant. This is again somewhat functional for its intended use but it is not functional for deterring abduction of a child from their bed.

An interesting reference is U.S. Pat. No. 4,411,034 entitled “BLANKET DEVICE WITH ALARM” wherein the blanket incorporates conductive snaps which when connected to an electrical circuit, will activate an audible sound if the connection is terminated. This device is somewhat functional because if an abductor were to disconnect the blanket so as to remove the child, the alarm would sound. However, in most cases the abductor would simply remove the child from within the blanket and the snaps would not be disconnected.

Other similar references include U.S. Pat. No. 5,144,284, No. 5,459,452, No. 5,844,488, and No. 4,853,692. Each of which pertain to alarms with monitoring system for a person while sleeping. However, in each case the main concern is to notify an attendant such as a nurse or caregiver that the person has wet the bed and/or they have moved into an undesirable position and assistance is required. Although the '692 reference also includes a transmitter that is attached onto the child and if removed and/or taken from a predetermined area, such as the maternity ward, an alarm is activated. In any case, neither system and/or alarm would be functional for deterring an abductor from taking a child from their bed.

### SUMMARY OF THE INVENTION

It is therefore a primary object of the present invention to provide an occupant detection safety system that senses critical information pertaining to an occupant when positioned thereon. Thus, upon detection of an emergency situation, such as if the occupant is removed from the predetermined space, (for instance their bed) an alarm is automatically activated. However, and most importantly the alarm is not only activated to warn the attendant but the system also simultaneously communicates with either ONSTAR™, AMBER ALERT™, a burglar alarm system, dials 911, and/or a combination thereof which is most novel and heretofore has not been taught.

Yet another important object of the present invention is to provide an occupant detection safety system that may be easily concealed or camouflaged in a manner so as to not to be easily detected by someone who may have suspicions that such a device is in use. Thus, the main components of the system are not visible upon first inspection.

Still another object of the present invention is to provide an occupant detection safety system that may be energized by any suitable means depending on engineering and/or end user preference. For example, the system may be energized via batteries, remote control, electrically wired, etc.

Another object of the present invention is to provide an occupant detection safety system that may be activated either “on” or “off” by any suitable means depending on engineering and/or end user preference. For example, the system may include voice recognition, it may simply be voice activated by vocalizing certain pre-programmed words, it may be triggered by a pre-programmed tone such as associated with an intercom system or phone, or it may simply have a concealed on/off switch either located thereon, therewith, or distanced there from, etc.

Still another object of the present invention is to provide an occupant detection safety system that may be used in combination with other types of safety devices. Thus, there may be an object positioned near the occupant such as a stuffed toy, a mirror, a light fixture, or the like, and when the alarm is activated, the object is also simultaneously activated. For example, the object may include a video recorder therein, a camera, or any other means for capturing the moment on film for evidence purposes. As another alternative, the noted object may also include an additional safety feature, such as a sensor beam or the like, and when disrupted automatically activates the safety system of the present invention.

A further object of the present invention is to provide an occupant detection safety system that is preferably tamper-proof. Thus if an intruder or unauthorized person tries to remove the system or disconnect any component thereof, the system is automatically activated.

Yet another object of the present invention is to provide an occupant detection safety system that is not only affordable, but is also cost effective to manufacture, is of simple construction, is very efficient, and easy to use and/or install.

Still a further object of the present invention is to provide an occupant detection safety system that may be sold in various kits, with each kit providing different combinations of components, thus the kits are variably priced for various users having different needs and/or financial status. Or the system may be sold independently with the other components being optional for purchase at a later date. The system may be completely self-contained and built within an item of choice (such as within a mattress) at the point of manufacture, or the system maybe produced as a retrofit allowing the end user to install the system within an item of their liking.

Other objects and advantages will be seen when taken into consideration with the following specification and drawings.

### BRIEF DESCRIPTION OF THE DRAWINGS

FIG. 1 is substantially a block diagram and flow chart for defining overall function and operational parameters for the present invention.

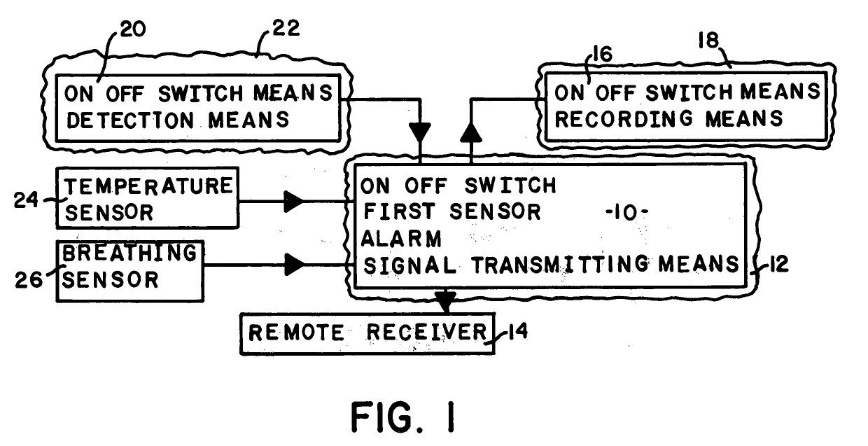

### DETAILED DESCRIPTION OF THE DRAWINGS

Referring now in detail to the drawing wherein like characters refer to like elements therein. The occupant detection safety system of the present invention substantially includes in combination a support housing (10) that is suitable for containment of an on/off switch, a first sensor, an alarm, and a signal transmitting means. It is to be noted any suitable support housing of engineering choice may be incorporated thus the actual structure thereof is not defined herein as numerous types of housing exist within the known prior art. However, it is would be most advantageous if such a support housing is compact, tamper-proof and made from a durable material.

It is to be further noted support housing (10) is to be either positioned under, upon, or within an object (12) of choice. For example, the noted object may be a mattress, bedding, a bed, a crib, or the like, depending on engineering preferences and/or the end user's requirements.

Still further, support housing (10) includes a signal-transmitting means that is in communication with a remote receiver means, and the remote receiver means is automatically activated upon receiving a signal from the signal-transmitting means. It is to be also noted that the actual electronics for the present invention are not defined herein as such electronics typically associated with transmitting and receiving devices are very well known and taught within the existing prior art. This is also true for the noted on/off switch that may be activated via numerous devices of choice. For example, the on/off switch maybe hard wired, wireless, battery operated, and/or activated via remote control, voice actuated, actuated by a pre-determined signal, tone, or the like. However, it is important that the on/off switch be inconspicuous, or distally located and not readily visible, as if the intruder is suspicious of such a system, the entire purpose would be defeated if they had easy access to the on/off switch.

The above noted prior art teachings also pertain to the sensors, each of which are later addressed herein, but each are again very well known in the prior art and there workings and internal components need not be addressed or taught herein.

It is to be understood that the remote receiver means is located at an emergency service provider's receiving system, such as either ONSTAR™, AMBER ALERT™, a police headquarters, or the like.

It is to be further understood the noted alarm may also be any suitable alarm device of engineering choice. Again the actual particulars pertaining to the alarm, such as electronic components are not taught herein, as many types of suitable alarms and how they function are very well known within the prior art. For example, the alarm device may be an audible sound, flashing lights, or the like. Also, if desired the alarm may be incorporated into an existing burglar alarm system installed within the premises, and/or the alarm may also automatically dial 911 upon actuation.

With reference to the preferred embodiment for the present invention, the noted first sensor is a weight sensor. Whereby, when the occupant is situated upon the object (12) the sensor registers the weight of the occupant. Thereafter, upon removal of the weight and/or a pre-programmed variance of the noted weight, the alarm and other system components are automatically activated. Thus, the noted pre-determined condition of an occupant in this case is determined by the occupant's weight.

It will now be seen, that when the on/off switch is in the on mode, and the first sensor is activated responsive to a pre-determined condition of an occupant when the occupant is positioned upon the object, the alarm is automatically activated, and the signal-transmitting means is automatically activated, which in turn automatically activates the receiver means located at the emergency service provider. Whereby, the emergency service provider notifies emergency personnel and/or authorities that emergency assistance is required at the noted premises.

For further clarification, it is to be understood the above system is completely functional in itself without any other needed components. However, if so desired other accessory options may be included depending on engineering and end user preferences.

For example, the following optional accessory safety item (16) is in the form of an on/off switch means interconnected to a recording means and may be easily incorporated in a concealed inconspicuous manner into any object (18) of choice. For example, it may be concealed and contained within a stuffed animal, within a mirror, a light fixture, etc., or within any other suitable object. Whereby, when the accessory item is in the off mode and then positioned at a location distanced from the support housing (10) and when the first sensor (namely weight sensor) is activated, the on/off switch means is automatically activated via first sensor, which in turn automatically activates the recording means. It is to be understood the noted recording means may simply be a video recorder with a videotape therein, a camcorder, DVD, CD, MP3, or any other type of suitable recording means of engineering choice. This is most advantageous, as if the intruder triggers the first sensor, (due to the intruder attempting to remove the occupant from within their bed) item (16) is simultaneously activated. Thus automatically recording the incident on a recording medium for viewing and/or evidence at a later date. With this in mind, the recording could easily be a life-saver and/or at least evidence that would be admissible in a court of law.

Yet another advantageous accessory item may be to include an automatic detection means for detecting movement within a pre-determined area. Again, any suitable detection means of engineering choice may be incorporated. However, as taught herein, the detection means (20) is contained within a second object (22) and includes an on/off switch means for activating the detection means. In this embodiment the detection means (20) is in the form of at least one sensor beam, and when activated (via the last noted on/off switch means) emits outwardly from the optional accessory safety item, such as object (22) toward the noted pre-determined area. This is very advantageous, as when the detection means is activated, and if the sensor beam is disrupted, (such as caused from an intruder walking within the noted area) the first sensor is automatically activated which in turn initiates other system components as previously described.

It is to be noted the detection means maybe either incorporated within a separate object (22) of choice, such as a stuffed animal and the actual sensor beam may emit inconspicuously from the eyes, or the like. It is to be understood the detection means is functional with only one sensor beam if it is positioned in a manner that one beam would suffice. However, in most cases at least two sensor beams would be desirable. Or if preferred, the detection means maybe incorporated into the first accessory item, such as object (18). Whereby, the recording means and detection means are used in combination. Thus, if the detection means is disrupted causing it to be triggered, the first sensor is automatically activated via the detection means, which in turn activates the alarm, transmitting and receiver means, and the recording means is activated by the alarm.

The occupant detection safety system of the present invention may further include a temperature sensor (24). This would prove to be most advantageous if the occupant were to become ill, resulting in a high fever that in turn would activate temperature sensor (24). Whereby, when temperature sensor (24) is activated, the alarm is automatically activated via temperature sensor (24) but first sensor, namely the weight sensor remains deactivated. This is important as the alarm would alert and/or awaken the occupant's attendant but the emergency provider would not be notified. Thus the attendant would be aware that the occupant was sick and needed attention, but emergency personnel would not be needlessly notified.

The occupant detection safety system of the present invention may further include a breathing sensor, (26). This would prove to be most advantageous if the occupant were to stop breathing and/or have difficulty in breathing, resulting in an interrupted or irregular signal that in turn would activate breathing sensor (26). Whereby, when the breathing sensor (26) is activated, the alarm is automatically activated via breathing sensor (26) but first sensor, namely the weight sensor remains deactivated. This is important as the alarm would alert and/or awaken the occupant's attendant but the emergency provider would not be notified. It is to be noted in this embodiment the pre-determined condition of the occupant would be a breathing disorder. However, within the previous mentioned embodiment, namely the temperature sensor, the pre-determined condition would be an unacceptable rise in the temperature of the occupant.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims, so as to embrace any and all equivalent devices and apparatuses.

1. An occupant detection safety system comprising: in combination a support housing for containment of an on/off switch; a first sensor; an alarm; and signal-transmitting means; said signal-transmitting means being in communication with a remote receiver means, said remote receiver means is automatically activated upon receiving a signal from said signal-transmitting means; and said support housing being either positioned under, upon, or within an object,
whereby:
when said on/off switch is on, and said first sensor is activated responsive to a pre-determined condition of an occupant when said occupant is positioned upon said object, said alarm is automatically activated, said signal-transmitting means is automatically activated which in turn automatically activates said receiver means, and said receiver means being located at an emergency service provider,
whereby:
said emergency service provider notifies emergency personnel that emergency assistance is required.

2. The occupant detection safety system of claim 1 wherein said first sensor is a weight sensor.

3. The occupant detection safety system of claim 1 wherein said emergency service provider is either, ONSTAR™, AMBER ALERT™, or a combination thereof.

4. The occupant detection safety system of claim 1 further includes at least one optional accessory safety item, said optional accessory safety item being distanced from said support housing, said optional accessory safety item having on/off switch means, and said optional accessory safety item having recording means,
whereby:
when said first sensor is activated, said on/off switch means is automatically activated which in turn automatically activates said recording means.

5. The occupant detection safety system of claim 1 further includes at least one optional accessory safety item, said optional accessory safety item being distanced from said support housing, said optional accessory safety item having detection means with on/off switch means for activating said detection means, and said detection means including at least one sensor beam which when activated emits outwardly from said optional accessory safety item toward a pre-determined area,
whereby:
when said detection means is activated, and said sensor beam is disrupted, said first sensor is automatically activated.

6. The occupant detection safety system of claim 1 further includes at least one optional accessory safety item, said optional accessory safety item being distanced from said support housing, said optional accessory safety item having recording means with an on/off switch means for activating said recording means, said optional accessory safety item having detection means with an on/off switch means for activating said detection means, and said detection means including at least one sensor beam which when activated emits outwardly from said optional accessory safety item toward a pre-determined area,
whereby:
said recording means and said detection means are used in combination, thus, if said detection means is disrupted causing it to be triggered, said first sensor is automatically activated via said detection means, which in turn activates said alarm, said signal transmitting means, said signal receiver means, and said alarm activates said recording means.

7. The occupant detection safety system of claim 1 further includes a temperature sensor,
whereby:
when said temperature sensor is activated, said alarm is automatically activated via said temperature sensor but said first sensor remains deactivated.

8. The occupant detection safety system of claim 1 further includes a breathing sensor,
whereby:
when said breathing sensor is activated, said alarm is automatically activated via said breathing sensor but said first sensor remains deactivated.
